(19) United States
(12) Patent Application Publication
(10) Pub. No.: US 2014/0151556 A1
(43) Pub. Date: Jun. 5, 2014

(54) DEVICE AND METHOD FOR ESTIMATING THE CONCENTRATION OF GAS RADON

(71) Applicants: Gian Franco Dalla Betta, Montebelluna (IT); Luigi Rovati, Modena (IT); Giovanni Verzellesi, Reggio Emilia (IT); Luca Bidinelli, Fanano (IT); Matteo Bonaiuti, Modena (IT); Davide Saguatti, Modena (IT); Andrea Bosi, Modena (IT)

(72) Inventors: Gian Franco Dalla Betta, Montebelluna (IT); Luigi Rovati, Modena (IT); Giovanni Verzellesi, Reggio Emilia (IT); Luca Bidinelli, Fanano (IT); Matteo Bonaiuti, Modena (IT); Davide Saguatti, Modena (IT); Andrea Bosi, Modena (IT)

(73) Assignee: RSENS S.R.L., 38122 TRENTO (IT)

(21) Appl. No.: 14/125,206

(22) PCT Filed: Jun. 12, 2012
(86) PCT No.: PCT/IB2012/052964

§ 371 Date: Jan. 15, 2014

(30) Foreign Application Priority Data
Jun. 14, 2011 (IT) MI2011A001073

(51) Int. Cl. G01T 1/178

(52) U.S. Cl. CPC G01T 1/178
USPC 250/336.1

(57) ABSTRACT

A device for measuring Radon gas concentrations comprises a measuring chamber (20) equipped with a detecting device (23), adapted to detect alpha particles from Radon gas; the device of the invention further comprises a collecting electrode (22) external to the measuring chamber (20), adapted to collect the electrically charged decay products of Radon coming from the measuring chamber (20). A control unit (30) times the passage between two operating stages (I, II) in which the detecting device (23) and the collecting electrode (22) are active at different times.

### FIELD OF APPLICATION

The object of the present invention is a device for measuring Radon gas concentration.

### BACKGROUND ART

There are known measurement systems for measuring concentrations of radioisotopes of Radon (²²²Rn).

The measurement principle is that the concentration of Radon is determined by means of detection of the alpha particles (a) emitted by decay of the nucleus of the isotope and its progeny.

The concentration of Radon, expressed in Bq/m³ (that is, radioactive events per second, per cubic meter of air), is in fact equal to the number of alpha particles emitted by the gas itself, referring to the unit of time and volume.

At present, the following systems are available for the measurement of Radon gas concentrations through alpha particles:

Ionisation Chambers

As they travel in air following emission, the alpha particles ionize the air molecules found on their path, producing an electrical charge that can be collected by an electrical field and measured.

This method is utilised when particularly accurate measurements of low concentrations of Radon are necessary.

This detecting device is of complex and costly construction, and it usually requires highly specialised operators for its use. Owing to these characteristics, it is considered to be a laboratory measurement method or even as a method for the calibration of other measurement instruments.

Scintillation Cells

The scintillation cell detection method is one of the oldest methods utilised in laboratories and in the field, for the detection of Radon gas.

The alpha particle transfers its energy upon contact with a material (scintillator), which emits an amount of photons that is proportional to the energy of the particle itself. With respect to the ionisation chamber method, the actual improvement contributed by the scintillation method, consists in the portability of the measurement system.

However, it is still a method typically reserved for laboratory use and generally for persons skilled in the art.

Nuclear Trace Detectors

The operating principle of these devices, which represent the most common type of passive devices, is based on the capacity of the alpha particles to produce traces in some sensitive materials. These materials must then be analysed by microscope examination in a laboratory. This measurement method thus requires the support of external facilities and this means that each measurement involves laboratory costs for determining the Radon concentration, in addition to replacement of the detector, which can only be used once.

Detectors with Active Carbon

The operating principle is simple: the Radon diffuses into the measuring chamber, where the active carbon is located. By passive diffusion, the carbon absorbs the radiation emitted by the Radon and stores traces of it. The same considerations concerning the analysis of the sensitive element mentioned in the preceding point hold true in this case as well.

Electret

The electret is a device consisting of an electrically charged disk made of dielectric material (generally Teflon) and positioned on the bottom of the measuring chamber. The electric potential of the electret is gradually reduced as the ions produced by decay of the Radon affect it, owing to the partial discharge that they bring about.

Solid State Detector

The operating principle of these systems is based on a detector made of silicon and capable of detecting the alpha particles emitted by decay of the Radon and its products. This system is completely autonomous and capable of supplying measurement data directly, as the central information (energy of the particle) is converted directly into an electrical quantity (charge) and can thus be easily managed for electronic retrieval of all the possible information, permitting the realisation of an active device.

Some of the technologies/systems described hereinabove can also be integrated with a suitable electronic system permitting the final user to obtain the result of the measurement directly in the desired form (concentration, exposure, etc.).

The devices described are not free from drawbacks. The more sensitive ones involve instrumentation that is generally complex, cumbersome and costly. On the other hand, the more economical ones that can also be used for domestic purposes, offer lower levels of sensitivity.

Moreover, both the more complex instruments and the more economical ones can exhibit high levels of uncertainty in measurements, due to the complex relation between real values of Radon gas concentration and those values measured by the measuring instruments that are influenced at least by the environmental conditions and/or by previous measurements.

The overall aim of the present invention is to supply a device for the measurement of Radon gas concentrations that is capable of resolving the problems described hereinabove.

The specific aim of the present invention is to supply a device for the measurement of Radon gas concentrations that is characterised by reduced measurement uncertainty, with respect to the inventions of the prior art.

### SUMMARY OF THE INVENTION

These and other aims are achieved by a device for measuring Radon gas concentrations, according to that which is described in the claims appended hereto.

The device, according to the invention, provides the following principal technical effects:
concentration measurement affected by less measurement uncertainty because it is not influenced by electrically charged residues from previous measurements;
subsequent measurements at shorter intervals of time because the measuring chamber is cleaned of residues from the previous surveys;
results containing more plentiful information;
greater reliability of the device;
improved data processing.

These and other technical effects of the invention will emerge in more detail from the description, provided hereinbelow, of examples of embodiments provided by way of indicative, and non-limiting example with reference to the accompanying drawings.

### BRIEF DESCRIPTION OF THE DRAWINGS

FIG. 1 is a block diagram of the device for measuring Radon gas concentrations, according to the invention.

FIG. 2 shows schematically a detail of the diagram appearing in FIG. 1, referring to different operating conditions.

FIG. 3 shows schematically a portion of the diagram appearing in FIG. 1, with which a user interfacing apparatus is associated, according to the invention.

FIG. 4 shows a module of the diagram appearing in FIG. 1.

FIG. 5 shows a block diagram of a variant of the user interfacing apparatus.

### DETAILED DESCRIPTION

A device for measuring Radon gas concentrations comprises a measuring chamber equipped with a detecting device, adapted to detect alpha particles from Radon gas; the device of the invention further comprises a collecting electrode external to the measuring chamber, adapted to collect the electrically charged decay products of Radon gas coming from the measuring chamber.

A control unit times the passage between the two operating stages in which the detecting device and the collecting electrode are active at different times.

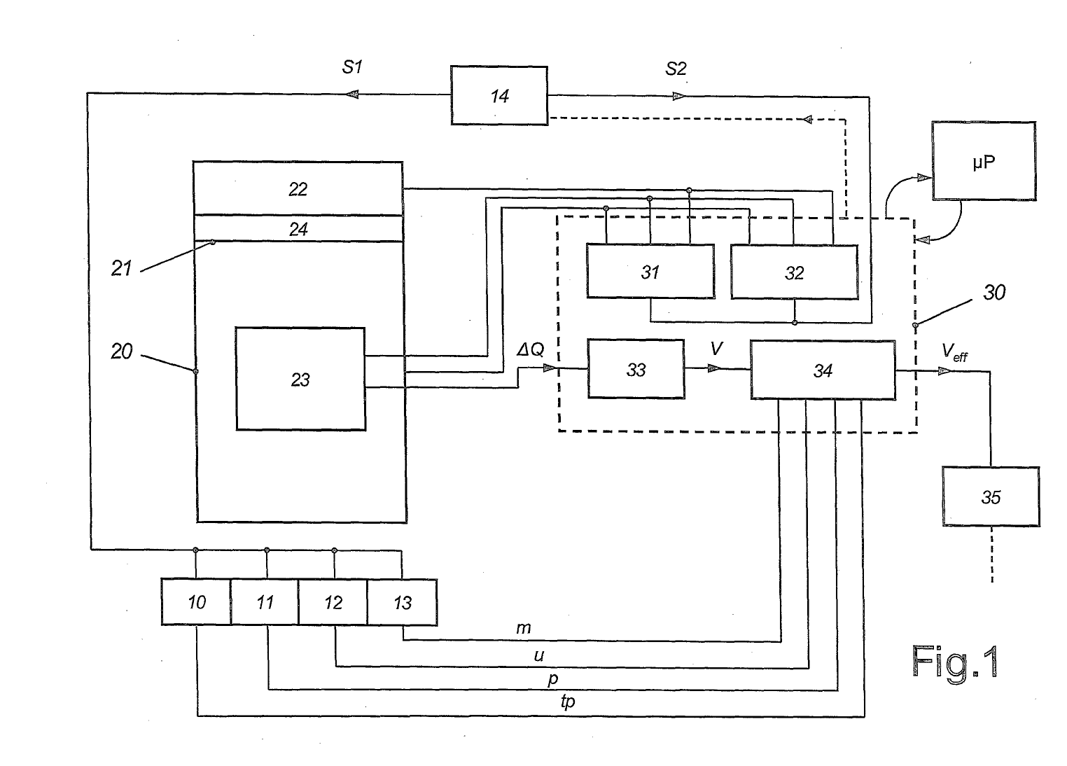

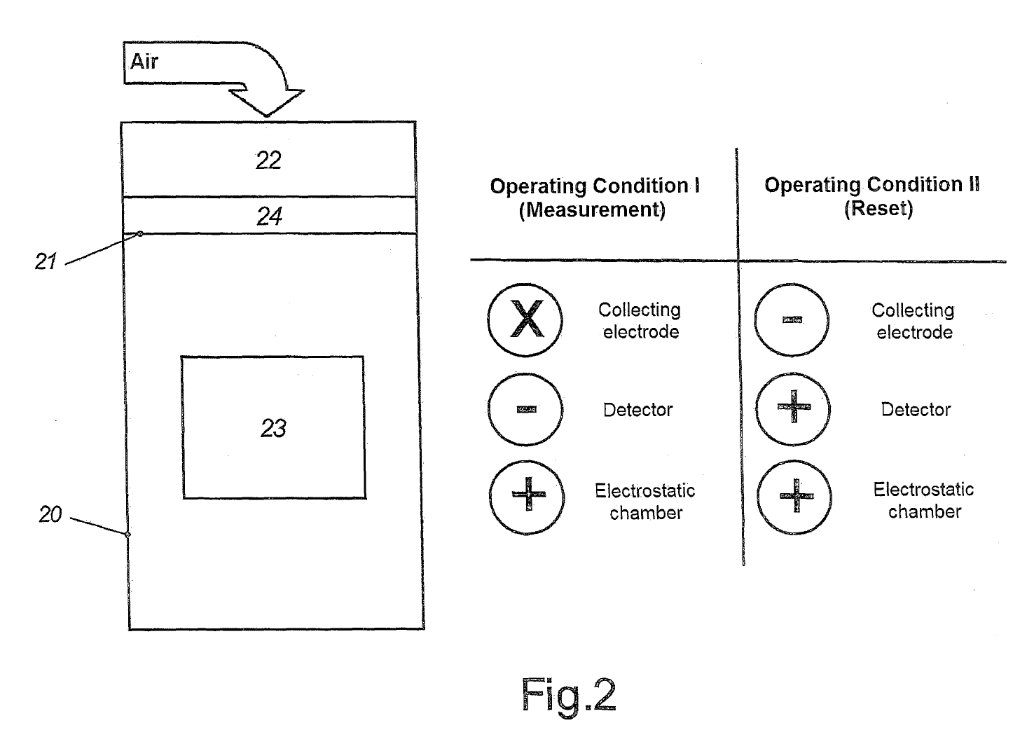

With particular reference to FIGS. 1 and 2, a device for measuring Radon gas concentrations, according to the invention, comprises an electrostatic measuring chamber 20.

The measuring chamber 20 delimits the working volume for measurement of Radon gas concentrations.

According to the invention, the measuring chamber 20 further contains a detecting device 23.

The detecting device 23 is adapted to detect alpha particles from Radon gas in the measuring chamber.

The detecting device 23 can be placed in any position inside the measuring chamber 20. This chamber 20 comprises an air inlet/outlet passage 21.

The device for measuring Radon gas concentrations, according to the invention, further comprises a collecting electrode 22 mounted externally of the above-mentioned measuring chamber 20, and in particular, in the proximity of the inlet/outlet passage 21. The collecting electrode 22 is adapted to collect electrically charged decay products of Radon gas coming from the measuring chamber 20, particularly through the inlet/outlet passage 21.

Preferably, the collecting electrode 22 comprises a metal element, which can be realised by means of a metal grid, a metal wire, or another geometrical form.

According to the invention, the detecting device 23 and the collecting electrode 22 are configured to operate under two possible operating conditions:
a first operating condition I, in which the detecting device 23 is active for a gas concentration measurement and the collecting electrode 22 is inactive.

In other words, this first operating condition I can be defined as a measurement stage in which the device of the invention carries out the measurement of the Radon gas concentration.
a second operating condition II, in which the collecting electrode 22 is active and the detecting device 23 is inactive.

In other words, this second operating condition can be defined as a resetting stage in which the device of the invention eliminates the electrically charged decay products inside the measuring chamber.

In yet other words, this second operating condition II carries out the removal of electrically charged residues inside the measuring chamber.

A first technical effect provided is a reduction of the measurement uncertainty of the measuring instrument.

A second technical effect provided is rapid emptying of the measuring chamber, which makes subsequent measurements possible at shorter intervals of time, and thus greater time resolution for measurements.

The measuring device of the invention further comprises a control unit 30 configured for timing the first I and the second II operating condition as a function of a first timing signal S1.

In general, it should be noted that in the present context and in the subsequent claims, the control unit 30 is presented as subdivided into distinct functional modules (memory modules or operating modules) for the sole purpose of describing the functions thereof clearly and thoroughly.

Actually, this control unit 30 can be made up of a single electronic device, suitably programmed to perform the functions described, and the various modules can correspond to hardware units and/or to routine software that are part of the programmed device.

Alternatively or additionally, such functions can also be performed by a plurality of electronic devices, on which the above-mentioned functional modules can be distributed.

The control unit can also make use of one or more processors (μP in FIG. 1) for the execution of the instructions contained in the memory modules.

The above-mentioned functional modules can also be distributed on different calculators in the local or remote mode based on the architecture of the network of residence.

With particular reference to FIG. 1, according to the invention, the control unit 30 comprises a first activation module 31 configured to activate the first operating condition I.

In particular, activation will take place at a time t=t1.

As shown in FIG. 2, the first activation module 31 activates this first operating condition I by:
polarising the detecting device 23 negatively;
polarising the electrostatic measuring chamber 20 positively;
maintaining the collecting electrode 22 disconnected.

In other words, under the first operating condition I, the polarisation of the elements is maintained in such a manner as to obtain the electrostatic collection of the ionised atoms of the radioactive decay of the Radon towards the detecting device 23 so as to permit the measurement thereof.

Under this first operating condition I, the collecting electrode 22 is not polarised and thus it does not intervene actively in the operation of the device of the invention, the detecting device 23 is polarised negatively and the electrostatic chamber 20 is polarised positively.

Under these conditions, an electrical field is generated, having the positive pole on the internal surface of the electrostatic chamber 20 and the negative pole on the detecting device 23, which pushes the ionised atoms inside the measuring chamber 20 onto the collection surface of the detecting device 23.

With particular reference to FIG. 1, according to the invention, the control unit 30 comprises a second activation module 32 configured to activate the second operating condition II for removal of the charged decay products.

In particular, activation will take place at a time t=t2>t1.

As shown in FIG. 2, the second activation module 32 activates this second operating condition II by:
polarising the detecting device 23 positively;
polarising the electrostatic measuring chamber 20 positively;
polarising the collecting electrode 22 negatively.

In other words, under the second operating condition II, the polarisation of the elements is modified (with respect to the first operating condition I) in such a manner as to obtain an electrostatic collection of the electrically charged decay products towards the collecting electrode 22 and no longer towards the detecting device 23.

In this manner, the ions present inside the measuring chamber 20, and on the internal surfaces thereof, are pushed out of the same chamber.

Under these conditions, an electrical field is generated, having a positive pole on all the internal surfaces of the measuring chamber 20 (the electrostatic chamber and detector) and a negative pole on the collecting electrode 22, which pushes the ions that are still present inside, towards the external collecting electrode 22.

The measuring device according to the invention comprises the filters 24 mounted at the inlets of the measuring chamber 20.

Once they have been attracted outside of the measuring chamber 20, the ions moved by the electrical field generated have no further possibility of re-entering inside the chamber owing to the filters 24.

Thus, the technical effect reached during this operating condition is the removal of the residues of the electrically charged radioactive decay produced by the previous measurements and possibly still present inside the measuring chamber 20.

According to the invention, the control unit 30 is configured to time the first I and the second II operating condition as a function of a first timing signal S1.

In particular, the measuring device according to the invention comprises a timing device 14 adapted to periodically generate the above-mentioned first timing signal S1.

In other words, the timing device 14, by means of the timing signal S1, times the polarisation of the measuring chamber 20, and/or of the collecting electrode 22, and/or of the detecting device 23, thereby controlling the two activation modules 31 and 32.

In other words, the activation modules 31 and 32 are adapted to connect the measuring chamber 20, and/or the collecting electrode 22, and/or the detecting device 23, to the corresponding potential as a function of the timing signal received.

According to the invention, the timing device 14 can be controlled with different modes:
manually: the timing device 14 is activated manually by the operator managing the measurement of Radon gas, who decides by means of an command (hardware or software) to activate the second operating condition II for removal and proceed to empty the electrostatic chamber 20 of the residual ions.
with automatic timing: the timing device 14 is activated automatically by the control unit 30 after a given time interval in which the instrument has remained on in the first operating condition I.
with automatic timing based on the radiation measured: the timing device 14 is activated automatically by the control unit 30, after a pre-established radiation dose has been measured. The control unit 30 of the invention calculates the sum of all the radiation to which the detector 23 has been subjected, starting from the previous second operating condition II and, as soon as it reaches the set threshold value, it performs the emptying.
automatically in continuous mode: the timing device 14 is automatically activated prior to the start of each measurement.

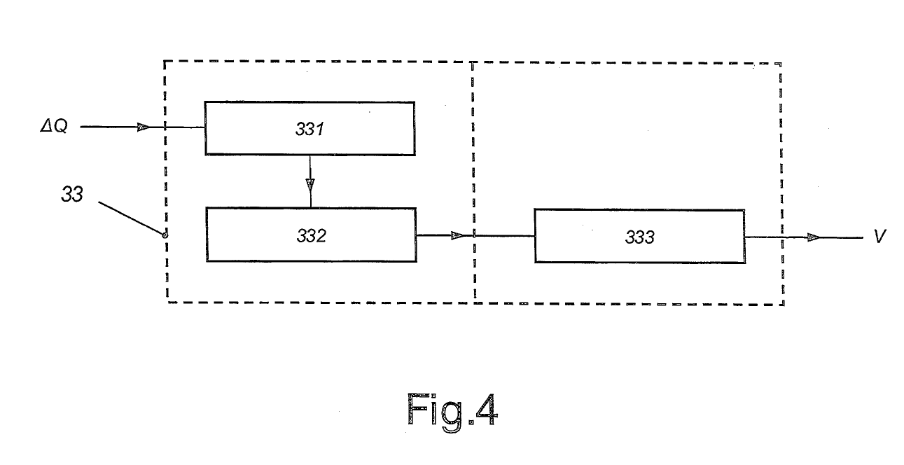

According to the invention, with particular reference to FIG. 4, the control unit 30 comprises a measurement module 33 adapted to receive a plurality of information on the electrical charge ΔQ from the detecting device 23, corresponding to subsequent measurements of a plurality of alpha particles present in the electrostatic measuring chamber 20.

The measurement module 33 comprises an integrating block 331 adapted to receive as input a quantity of electrical charge ΔQ generated by the alpha particles inside the detector 23 and to supply as output a voltage descriptive of that quantity of electrical charge ΔQ.

The integrating block carries out the conversion by means of a suitable electrical circuit. The measurement module 33 further comprises a sampling block 332 adapted to digitise the electrical voltage value obtained.

In other words, the measurement module 33 ensures the detection of every radioactive event characterising the Radon decay process.

Lastly, the measurement module 33 comprises a processing block 333 adapted to calculate a concentration value V of Radon gas, starting from the digitised value of the sampling block 332.

The concentration value is preferably expressed in Bq/m³.

The processing block 333 uses a suitable calibration curve, obtained by means of measurements on the detecting device of the invention, and an algorithm for processing the digitised information produced by the sampling block 332.

In addition to counting the alpha particles, from which one obtains the concentration of the gas, the measuring device of the invention is capable of storing the values over time of three more physical quantities referring to the environment, namely, air temperature, pressure, and humidity, and of another physical quantity relating to the measuring device, namely, movement, preferably in terms of the spatial orientation of the measuring device.

Therefore, the measuring device of the invention is capable of storing values for a total of five physical quantities as a function of time.

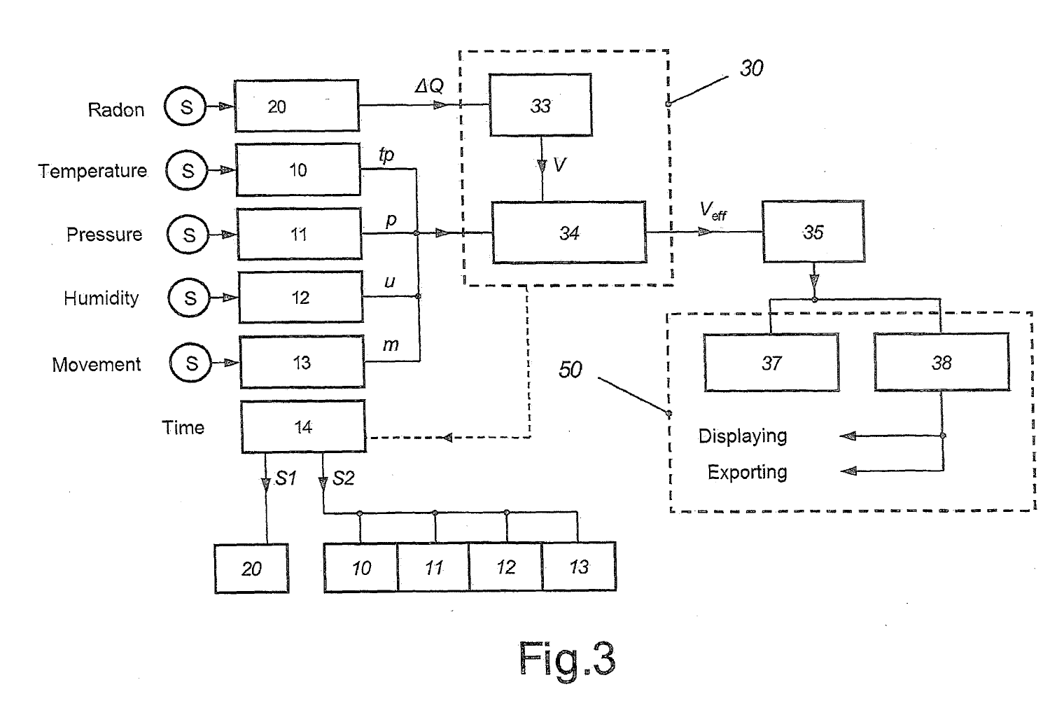

FIGS. 1 and 3 are block diagrams showing the interactions between the functional components that execute the functions described.

With reference to FIGS. 1 and 3, the measuring device of the invention comprises one or more temperature sensors 10, adapted to measure a temperature value tp of the air; pressure sensors 11, adapted to measure a pressure value p of the air; humidity sensors 12, adapted to measure a humidity value u of the air; spatial-orientation sensors 13, capable of acquiring a value for the movement m of the measuring device.

Preferably, the tp, p, u and m values are measured during the first operating condition I. Alternatively, or additionally, the tp, p, u and m values are measured during the second operating condition II.

According to the invention, (FIG. 1) the timing device 14 is adapted to periodically generate a second timing signal S2 capable of carrying out the timing of a query of the sensors cited hereinabove.

According to the invention, the second timing signal S2 activates the query of the sensors 10, 11, 12 and 13 in parallel.

The technical effect provided is a faster processing of the collected data.

As stated previously, the timing device 14 is also capable of periodically generating the first timing signal S1 for the two activation modules 31 and 32.

According to the invention, the first timing signal S1 activates the first operating condition I in parallel with the activation, by the second timing signal S2, of acquisition by means of the sensors 10, 11, 12 and 13.

In other words, according to the invention, the timing device 14 is adapted to generate the first timing signal S1 and the second timing signal S2 in such a manner that the first operating condition I of the measuring device and the query of one or more of the temperature sensors 10, pressure sensors 11, humidity sensors 12 and spatial-orientation sensors 13 will be accomplished in parallel.

The technical effect provided is an improved and faster data processing, in that the quantities involved are acquired and processed in parallel.

The physical quantities corresponding to temperature, pressure, humidity and movement are converted by the respective sensors, acquired in digital form and transmitted to the control unit 30.

According to the invention, the control unit 30 comprises a compensation module 34 (FIG. 1) adapted to receive as input the concentration value V of Radon gas calculated by the measurement module 33.

The compensation module 34 is also adapted to receive as input one or more of the measured air temperature tp, air pressure p, air humidity u, and device movement m values.

The compensation module 34 is also adapted to calculate an actual concentration value V_{eff} of Radon gas as a function of the concentration value V and the measured temperature tp, pressure p, humidity u, and movement m values.

In particular, the actual concentration value V_{eff} is a function of measurements carried out in the same instant of time t, namely:

V_{eff}(t+Δt)=f(tp(t);p(t);u(t);m(t)).

The measuring device of the invention comprises a memory 35 (FIGS. 1 and 2) adapted to contain the acquired values of the five physical quantities.

In particular, these values can be stored in a matrix ordered on the basis of the instant of time of the survey.

The memory 35, according to the invention, is connected to the control unit 30.

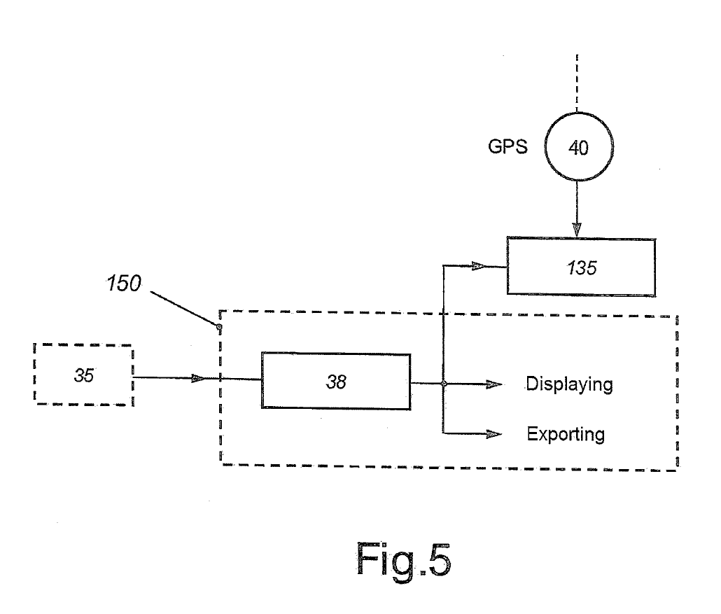

The measuring device, according to the invention, comprises a user interfacing apparatus 50, 150 (FIGS. 3 and 5) on which the information contained in the memory 35 can thus be easily displayed.

In particular, data relating to a particular instant of time or mediated in a particular interval of time can be displayed.

A first user interface 37 can be provided on the measuring device in the user interfacing apparatus 50.

Alternatively, or additionally, a second interface 38 may be of the graphic type (GUI) and provided with software for wireless communication with various personal computers.

This second interface 38 permits the connection of more than one measuring device of the invention, by means of the various personal computers, so as to extend the area of investigation.

The second interface 38, according to the invention, is configured so as to enable programming of a beginning and the duration of the measurements, as well as exporting of the data saved in the memory 35.

A summary chart can in fact be viewed upon completion of the measurements made. Alternatively, a more accurate analysis (and thus also suitable for persons skilled in the art) can be carried out by exporting the data in a format compatible with the more common spreadsheets.

The measuring device, according to a variant of the invention, comprises a user interfacing apparatus 150 (FIG. 5).

A GPS-based localisation sensor 40 is associated with this apparatus to record the position of a measuring device that has just carried out a measurement.

The measuring device is adapted to connect with a remote memory 135, in particular, a remote database 135 (cloud) in which the acquired data are stored.

The remote database 135 comprises measurement data stored on the basis of the instant of time of acquisition and the changes in the position of the measuring device.

In this manner, as measurements are gradually carried out, the memory 135 is updated and will represent a sample that is increasingly descriptive of the situation in the geographic area in terms of the Radon concentrations, permitting the user to compare his/her own measurements with those already carried out in the neighbouring areas, displaying for example a colour-scale map that can be compared with those existing in the literature.

The second memory 135, according to the invention, is connected to the user interfacing apparatus 150 in which the second interface 38 performs the functions previously described.

The second memory 135, according to the invention, is also connected to the control unit 30 of the respective device for measurement of Radon gas concentrations.

To sum up, in accordance with the above, the first memory 35 and the second memory 135 are adapted to contain one or more of the acquired values of concentration V of Radon gas, actual values V_{eff} of Radon gas calculated on the basis of the concentration value V, and measured values of temperature tp, pressure p, humidity u and movement m.

1-10. (canceled)

11. A device for measuring Radon gas concentration, comprising:
an electrostatic measuring chamber including a detecting device adapted to detect alpha particles from Radon gas in said electrostatic chamber;
a collecting electrode mounted externally of said measuring chamber and adapted to electrostatically collect the electrically charged radioactive decay products of Radon gas coming from said electrostatic measuring chamber;
said detecting device and collecting electrode being configured for operating between:
a first operating condition for measurement of the gas concentration in which said detecting device is active and said collecting device is inactive;
a second operating condition for removal of electrically charged residues, in which said collecting electrode is active and said detecting device is inactive;
a control unit configured for timing said first and second operating conditions as a function of a first timing signal.

12. A measuring device as claimed in claim 11, wherein said control unit comprises a first activation module configured for activating said first operating condition by
polarising said detecting device negatively;
polarising said electrostatic measuring chamber positively;
maintaining said collecting electrode disconnected.

13. A measuring device as claimed in claim 11, wherein said control unit comprises a second activation module configured for activating said second operating condition by
polarising said detecting device positively;
polarising said electrostatic measuring chamber positively;
polarising said collecting electrode negatively.

14. A measuring device as claimed in claim 12, wherein said control unit comprises a second activation module configured for activating said second operating condition by
polarising said detecting device positively;
polarising said electrostatic measuring chamber positively;
polarising said collecting electrode negatively.

15. A measuring device as claimed in claim 14, wherein said control unit comprises a first measurement module adapted to receive a plurality of information on the electric charge from said detecting device and calculate a corresponding concentration value of Radon gas, said measurement module comprising:
an integrating block adapted to convert said electric charge into an electric-voltage value;
a sampling block adapted to digitise said electric-voltage value in real time;
a processing block adapted to obtain a corresponding concentration value of Radon gas.

16. A measuring device as claimed in claim 11, comprising one or more of:
temperature sensors adapted to measure a temperature value of the air;
pressure sensors adapted to measure a pressure value of the air;
humidity sensors adapted to measure a humidity value of the air;
spatial-orientation sensors adapted to measure a spatial-orientation value of said measuring device.

17. A measuring device as claimed in claim 11, comprising a timing device adapted to periodically generate said first timing signal.

18. A measuring device as claimed in claim 17, wherein said timing device is adapted to periodically generate a second timing signal capable of carrying out timing of a query of said one or more temperature sensors, pressure sensors, humidity sensors, movement sensors.

19. A measuring device as claimed in claim 18, wherein said timing device is adapted to generate said first timing signal and said second timing signal so that said first operating condition and said query of one or more of said temperature sensors, pressure sensors, humidity sensors, movement sensors will be accomplished in parallel.

20. A measuring device as claimed in claim 16, wherein said control unit comprises a compensation module adapted to:
receiving as input said concentration value of Radon gas;
receiving as input one or more of said acquired temperature, pressure, humidity, spatial orientation values;
calculate a true concentration value of Radon gas as a function of said concentration value and said acquired temperature, pressure, humidity, spatial orientation values.

21. A measuring device as claimed in claim 17, wherein said control unit comprises a compensation module adapted to:
receiving as input said concentration value of Radon gas;
receiving as input one or more of said acquired temperature, pressure, humidity, spatial orientation values;
calculate a true concentration value of Radon gas as a function of said concentration value and said acquired temperature, pressure, humidity, spatial orientation values.

22. A measuring device as claimed in claim 18, wherein said control unit comprises a compensation module adapted to:
receiving as input said concentration value of Radon gas;
receiving as input one or more of said acquired temperature, pressure, humidity, spatial orientation values;
calculate a true concentration value of Radon gas as a function of said concentration value and said acquired temperature, pressure, humidity, spatial orientation values.

23. A measuring device as claimed in claim 19, wherein said control unit comprises a compensation module adapted to:
receiving as input said concentration value of Radon gas;
receiving as input one or more of said acquired temperature, pressure, humidity, spatial orientation values;
calculate a true concentration value of Radon gas as a function of said concentration value and said acquired temperature, pressure, humidity, spatial orientation values.

24. A measuring device as claimed in claim 15, comprising a memory adapted to contain one or more of said:
measured concentration value of Radon gas;
values of Radon gas calculated as a function of said concentration value;
measured temperature, pressure, humidity, spatial orientation values;
said memory being connected to said control unit;
said memory being connected to a user interfacing apparatus.

25. A measuring device as claimed in claim 16, comprising a memory adapted to contain one or more of said:
measured concentration value of Radon gas;
values of Radon gas calculated as a function of said concentration value;
measured temperature, pressure, humidity, spatial orientation values;
said memory being connected to said control unit;
said memory being connected to a user interfacing apparatus.

26. A measuring device as claimed in claim 20, comprising a memory adapted to contain one or more of said:
measured concentration value of Radon gas;
values of Radon gas calculated as a function of said concentration value;
measured temperature, pressure, humidity, spatial orientation values;
said memory being connected to said control unit;
said memory being connected to a user interfacing apparatus.

27. A measuring device as claimed in claim 21, comprising a memory adapted to contain one or more of said:
measured concentration value of Radon gas;
values of Radon gas calculated as a function of said concentration value;
measured temperature, pressure, humidity, spatial orientation values;
said memory being connected to said control unit;
said memory being connected to a user interfacing apparatus.

28. A measuring device as claimed in claim 22, comprising a memory adapted to contain one or more of said:
measured concentration value of Radon gas;
values of Radon gas calculated as a function of said concentration value;
measured temperature, pressure, humidity, spatial orientation values;
said memory being connected to said control unit;
said memory being connected to a user interfacing apparatus.

29. A measuring device as claimed in claim 23, comprising a memory adapted to contain one or more of said:
measured concentration value of Radon gas;
values of Radon gas calculated as a function of said concentration value;
measured temperature, pressure, humidity, spatial orientation values;
said memory being connected to said control unit;
said memory being Connected to a user interfacing apparatus.
